(19) United States
(12) Patent Application Publication
(10) Pub. No.: US 2010/0018096 A1
(43) Pub. Date: Jan. 28, 2010

(54) Method of Stadium Advertising

(76) Inventor: Nicole B. Fein, Boston, MA (US)

Correspondence Address: JACQUELINE TADROS, P.A., 500 CYPRESS CREEK ROAD WEST, SUITE 350, FORT LAUDERDALE, FL, 33309, US

(21) Appl. No.: 12/508,622

(22) Filed: Jul. 24, 2009

Related U.S. Application Data
(60) Provisional application No. 61/135,849, filed on Jul. 24, 2008.

(51) Int. Cl. G09F 15/02

(52) U.S. Cl. 40/606.18

(57) ABSTRACT

A dual method of remote concession ordering and stadium advertising in sports venues and arenas. The method utilizes an apparatus comprising a spiral coil. The spiral coil retains front and rear jacket panels and binds panels or sheets within the front and rear jacket panels. The generic names of concession food items are successively displayed on one side of the panels or sheets. Sponsorship advertising is displayed on an opposite side of the panels or sheets, such that when a spectator or event attendee holds the apparatus of the present invention in the air to order a food or beverage item, the generic term will be displayed and visible to the vendor, while people seated in rows behind the event attendee or spectator may be able to view the advertisement.

### CROSS-REFERENCE TO RELATED APPLICATIONS:

Applicant claims priority from co-pending Provisional Patent Application No. 61/135,849 filed on Jul. 24, 2008 and entitled CANVAS HOLDER FOR EASEL under Title 35, United States Code Section 119(e). An entire copy of Provisional Patent Application No. 61/135,849 is incorporated herein by reference.

### TECHNICAL FIELD OF THE INVENTION

The invention relates generally to the field of stadium advertising and more particularly to a novel and dual method of remote concession ordering and stadium advertising in sports venues and arenas.

### BACKGROUND OF THE INVENTION

Strategic stadium advertising offers merchants expanded marketing opportunities. Stadium advertising opportunities range from billboards and bulletins, to print campaigns and digital media ads.

Vendors recognize the inherent value in marketing their goods and services to a select and captive audience comprising a specific and targeted demographic.

It is known in the art to use placards in stadium advertising. For example, U.S. Pat. No. 7,121,621 to Starheim et al. for an “Information Placard Holder for a Stadium Seat” discloses a flexible panel having a window aperture with a clear covering and a pocket behind the window for holding an information containing placard.

Another advertising system is disclosed in U.S. Pat. No. 6,908,653 (to Keane). Keane teaches a system for making at least one visual advertisement using a stepped surface. One or more decals are displayed on the stepped surface, thus providing a means for a merchant to display its advertising.

U.S. Pat. No. 6,478,371 (to Clarke) teaches a “Retractable and Removable Concession Holder for Stadium Seating”. The holder is affixed to seating commonly found in large capacity entertainment facilities. The holder comprises a concession container displaying advertising information, a mounting bracket and a seat attachment bracket and a seat attachment portion. The seat attachment portion is permanently affixed to the underside of the seat in such a fashion that the concessions container can be brought from an operating position in between the seated patron's legs to a stowed position under the seat and out of the way of the patron.

U.S. Pat. No. 5,941,002 (to Rusin) discloses a “Stadium Signage System and Method” for displaying promotional or informational signs at field events. The signage system is used in stadiums having a grandstand facing a playing field. The signage system further includes a support frame and a pair of mounting stands.

Enjoying food, beverages and snacks at a sporting event is an integral part of the stadium experience. The traditional alternative to leaving your seat at a stadium and being trampled in the crowd involves flagging down a food vendor.

One of the difficulties associated with this method is it that it is often difficult to secure the food vendor's attention. Another challenge is that once the vendor's attention is secured, it may be hard to convey the specific food order to the vendor because of the noise factor in the stadium.

Remote ordering systems have thus been introduced in an attempt to overcome these inconveniences. U.S. Pat. No. 6,920,431 (to Showghi et al.) discloses a “Remote Ordering System and Method” which enables patrons at large venues to use hand-held wireless communication devices to order food, beverages and souvenir items.

U.S. Pat. No. 6,920,431 (to Showghi et al.) discloses a remote ordering system and method to enable patrons at large venues, conventions halls or airports Cisco® unified IP phone allows spectators at sporting events order snacks remotely.

Effective marketing programs to promote a particular brand are often extremely costly and difficult to implement.

Print campaigns figure prominently in stadium advertising because they are a proven and effective marketing technique. Flyers represent a low budget method of print campaigns that can be used in stadium advertising. The difficulty with flyers is that they are flimsy and often end up on the floor in a battered condition. This reflects poorly on the advertiser and also litters the stadium.

Another form of print advertising is advertising on event tickets, as well as valet and parking garage tickets. Many companies have found this form of advertising to be effective. One of the reasons is that event attendees are less apt to dispose of their event tickets or valet and garage tickets until the event is over and they have left the stadium. The reason for this is simply that the ticket, whether it be an event ticket or a parking or valet ticket has value to the attendee. Thus, this form of advertising avoids some of the disadvantages of advertising on flyers. The disadvantage of this form of print advertising, however, is the limited space availability on the tickets. The limited space available on tickets seriously hampers the advertisers options in creating effective advertising.

U.S. Pat. No. 4,238,897 (to Byers) teaches a “Two Faced Display Holder” for presenting a display with a placard. The display holder preferably includes a first display member and a second display member that each define a channel for slidably receiving and retaining an object of visual observation, such as a placard. Thus, the two faced display holder of Byers extends the useful life of a placard by permitting easy and neat variation of temporarily featured sale prices.

U.S. Patent Application No. 2003/0019136 (to Whitman) discloses a method and apparatus for advertising intended for use in displaying advertising information to passengers within an aircraft. The advertisement display device is attached to a surface on an aircraft tray table. The method of advertising includes providing an advertisement display device and adhering the device to a suitable display surface on a tray table within the aircraft so that the advertisement information can be viewed by a passenger on an aircraft.

U.S. Patent Application No. 2003/0188469 (to Torres) describes a method of advertising using removable apparel panels. A plurality of cloth-like front and rear panels having advertising depicted thereon are attached in a staggered fashion to an athlete's uniform or equipment. A panel is removed periodically to reveal another panel depicting new advertisement.

A binder with internal poster is depicted in U.S. Pat. No. 7,316,517 (to Russo). The binder or notebook of Russo includes one or more internal folded sheets, preferably in the form of poster panels, which may be disposed within the binder or notebook and thereafter removed for display separate from the binder or notebook,

The foregoing inventions disclose methods and devices for, advertising, stadium advertising and food and beverage ordering. However, none of the foregoing inventions provides a method of ordering food and beverage in a stadium environment that simultaneously functions as a stadium advertising method in the manner provided by the present invention.

Thus, there is a need for an improved system of ordering food and beverage which also combines a method of stadium advertising which will benefit stadium attendees and advertisers and increase revenue.

### BRIEF SUMMARY OF THE INVENTION

The general purpose of the present invention, which will be described subsequently in greater detail, is to provide a novel system for stadium advertising which simultaneously accomplishes the dual objective of vendor advertising in a stadium while providing a method of ordering food and beverage from a vendor.

The apparatus and method of the present invention comprise a system for event attendees to gain the attention of a vendor for the purpose of ordering food and beverages while simultaneously allowing advertisers to reach event attendees in a stadium who will view the advertisement during the event when a fellow attendee disposed in a row in front of them holds the apparatus in the air to attract the attention of a food and beverage vendor.

The invention permits great creativity in the type of indicia which may be used. For example, studies indicate that certain colors stimulate appetite and a desire for a particular food or beverage. Thus, a food vendor advertising the sale of beer may want to use yellow as a background color, or a hot dog vendor may want to use red to stimulate a desire for hot food. Similarly, pink for cotton candy and blue for water. Other colors may also be associated for sweet and salty foods.

The apparatus comprises a spiral or a ring binder with a narrow spine. The inventive device is further defined by front and back surfaces. The surfaces are preferably laminated to provide additional protection from food or beverage spills and leaks.

Both the front and back surfaces of the apparatus provide additional opportunities for an advertiser to promote a product, service or event. For example, a baseball team may include its logo on the front or back surface while another major sponsor may opt for the back surface.

The spiral or ring binder further includes numerous sheets that may be laminated for additional protection. The sheets are perforated to adapt to a spiral or ring binder. One side of a sheet contains one or more terms identifying a food or beverage item. For example, BEER, WATER, HOT DOG, COTTON CANDY, PEANUTS and the like. The opposite side of a sheet displaying a generic term for a food item will be available for marketing, including but not limited to advertisements and coupons. The advertisement may or may not relate to a food item.

An advantage of the present invention is that it provides an effective yet economical method for an advertiser to reach a captive and select demographic that are very open and receptive to their particular product or service. For example, Anheuser-Busch® may sponsor an ad for beer, on a sheet adjacent to another sheet which contains the generic term BEER. Similarly Planters® may sponsor an ad on a sheet adjacent to a sheet which contains the generic term PEANUTS, such that when the apparatus is held in the air by the attendee to signal to the vendor that they wish to order a bag of peanuts, the adjacent sheet will be displayed to the attendees disposed to view the adjacent sheet with the advertisement for Planters® peanuts.

Thus, when a spectator or event attendee holds the apparatus of the present invention in the air to order a food or beverage, the generic term will be displayed and visible to the vendor, while people seated in rows behind the event attendee or spectator may be able to view an advertisement for the particular food item on the adjacent sheet. Alternatively, the adjacent sheet may offer a coupon for a local restaurant, store and the like, thereby providing a vendor with additional marketing opportunities.

An advantage of the present invention is that it provides advertisers with a valuable opportunity to offer targeted and cross promotional branding.

Yet another advantage of the present invention is that the relatively minimal cost also is very advantageous to advertisers, as it provides the advertiser with flexibility in their marketing efforts.

An object of the present invention is to provide a dual method for stadium attendees to order food or beverages from a vendor while simultaneously acting as a conduit for an advertiser to promote a particular brand.

Another object of the apparatus and method of the present invention is to provide attendees with an orderly method in which to order food or beverage items from a vendor without having to resort to yelling and screaming over a crowd.

Yet another object of the present invention is to provide advertisers with flexibility in the type of indicia which may be used, thereby permitting ample opportunity to present the advertiser's message in a highly creative manner.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the present invention

There has thus been outlined, rather broadly, the more important features of the invention in order that the detailed description thereof may be better understood, and in order that the present contribution to the art may be better appreciated. Other features and advantages of the present invention will become apparent from the following more detailed description, taken in conjunction with the Brief Description of the Drawings and accompanying drawings, which illustrate, by way of example, the principles of the invention, as well as the Detailed Description of the Invention and Claims appended herewith.

### BRIEF DESCRIPTION OF THE DRAWINGS

A complete understanding of the present invention may be obtained by reference to the accompanying drawings, when considered in conjunction with the subsequent, detailed description, in which:

FIG. 1 illustrates a front operational view of the present invention displaying a food concession item;

FIG. 2 illustrates a top view of the present invention;

FIG. 3 illustrates a side perspective operational view of the present invention;

FIG. 4 illustrates a rear view of the present invention displaying a logo of a sports team;

FIG. 5 illustrates a rear operational view of the present invention for placement of an advertisement;

FIG. 6 illustrates a front surface view of the present invention displaying the logo of another sports team; and

FIG. 7 illustrates a front operational view of an alternative embodiment of the present invention.

For purposes of clarity and brevity, like elements and components will bear the same designations and numbering throughout the Figures.

### DETAILED DESCRIPTION OF THE INVENTION

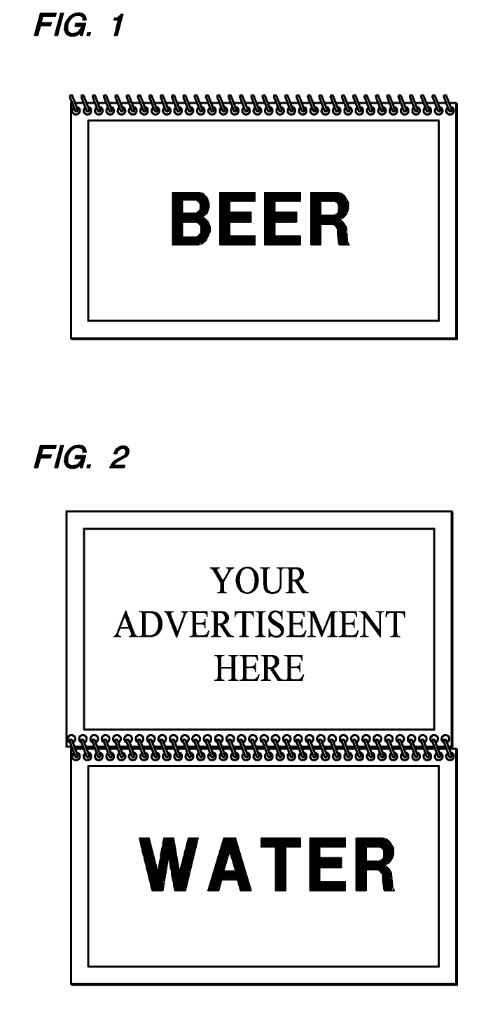

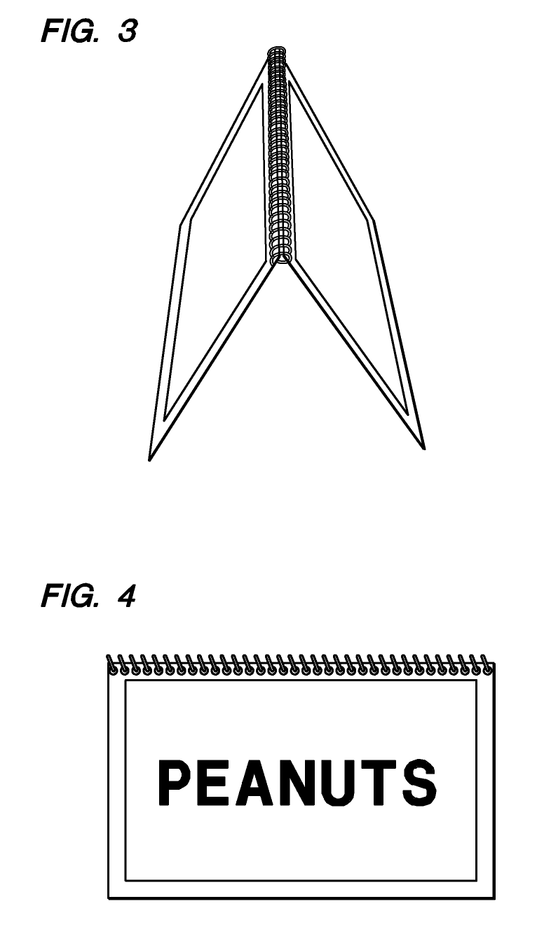

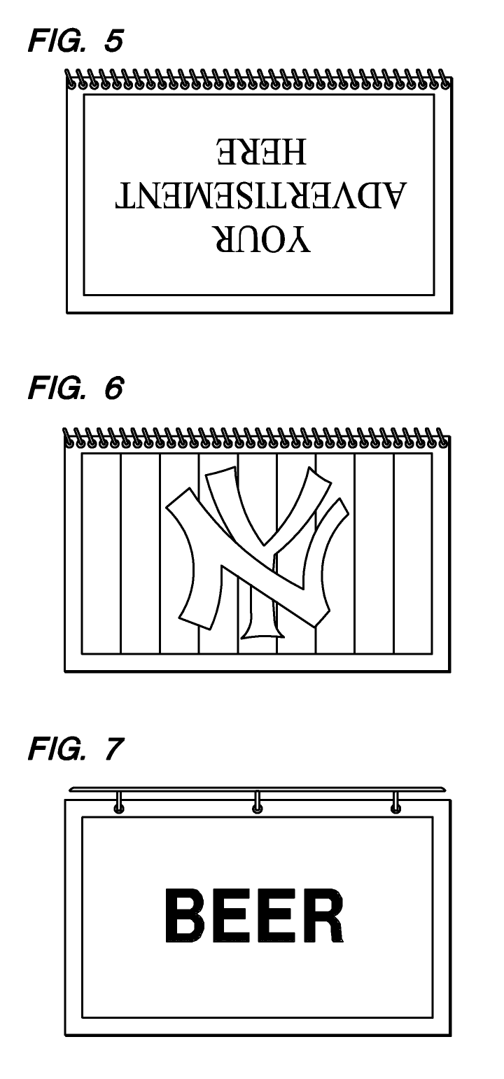

The present invention is described with references to the enclosed Figures wherein the same numbers are utilized where applicable. Referring now to FIGS. 1 to 7, in one embodiment, the present invention provides a spiral book shown generally at reference numeral 1 in which a coiled spiral 10 retains sheets or poster panels 12 in place. The sheets 12 are contained between a front jacket 14 and a rear jacket 16. The front and rear jackets 14, 16 are also retained by the coiled spiral 10.

The coiled spiral 10 is preferably made of plastic or steel or some other suitable material known in the art.

The sheets 12 and jackets 14, 16 are provided with perforations 18 such that the steel or plastic PVC coils of the spiral 10 easily spin through the punched paper and are then cut and crimped to prevent the coil 10 from spinning back out.

In a preferred embodiment, the sheets 12 as well as the front and rear jackets 14, 16 are laminated. The laminating process as will be appreciated by those skilled in the art may be achieved by sandwiching the sheets 12 and front and rear jackets 14, 16, individually, between layers of plastic and sealing them with heat and/or pressure and an adhesive.

In an alternative embodiment, the spiral book 1 is replaced by a ring binder shown generally in FIG. 7. The ring binder may include a spine 20 and one or more rings 18 sheets 12 and front and rear jackets 14, 16. The spine 20 joins the jackets 14, 16 and also provides a mounting for the rings 22 that open and close to hold the sheets 12 within the ring binder.

The spine 20 may be composed of steel, plastic or other suitable material as is known in the art. The spine 20 is preferably between one eighth and one half inch in width to enable the user to easily maneuver the apparatus in the proscribed manner.

The sheets 12 and jackets 14, 16 are provided with holes 24. Each hole 24 is situated to cooperate and be received by one of the binder rings 18.

In an alternative embodiment, the ring binder may include one or more rings 18 sheets 12 and front and rear jackets 14,16 and not include a spine.

Referring now to FIGS. 4 and 6, the front and rear jackets 14, 16 may include marketing or promotional material, for example, coupons for restaurants, stores and the like, as well as advertising or sponsorship indicia, such as graphics, a trademark or logo, shown generally by reference numerals 26 and 28. In addition to advertising goods and services, a sponsor may elect to display a logo of a sports team or event headliner.

The apparatus and method of the present invention provides marketing opportunities and a system for advertisers to reach event attendees in a stadium who will view the advertisement during the event when a fellow attendee disposed in a row in front of them holds the apparatus in the air to attract the attention of a food vendor. As an attendee rotates, it is also expected that fellow attendees disposed adjacent to the attendee or in an otherwise favorable position to view the advertisement will be able to view the advertisement.

Coupons (not shown here) may also be disposed on the front and rear jackets, 14, 16, thereby providing additional marketing opportunities for a vendor and an additional benefit to the attendee in possession of the apparatus of the present invention.

Advertisements 30 and generic terms identifying concession food and beverage items 32 are printed or otherwise disposed on the sheets in a sequential manner, wherein the sheets include a concession food item or beverage on a first side of a sheet and one or more indicia of marketing 30, including advertisements on an opposite side of the sheet such that the advertisement is prominently displayed to attendees disposed to view it while the apparatus is being held in the air by a fellow attendee ordering a food item or beverage from a vendor. A vendor may also utilize the opposite side of the sheet to include one or more coupons or other forms of marketing.

In a preferred embodiment the first side of a sheet 12 displaying a generic food item is color coordinated to stimulate appetite and a desire for a particular food or beverage item. For example, yellow as a background color for the generic term BEER or red as a background color for the generic term HOT DOG.

In an alternative embodiment, the opposite side of the sheet 12 is used for marketing generally, including and not limited to, the offering of coupons for a local establishment, store or restaurant and the like.

The apparatus and method of the present invention may be used in large capacity entertainment establishments, such as theaters, stadiums, amphitheaters and sporting arenas.

While there has been shown and described the preferred embodiments of the instant invention it is to be appreciated that the invention may be embodied otherwise than is herein specifically shown and described and that, within said embodiments, certain changes may be made in the form, dimensions and arrangement of the parts without departing from the underlying ideas or principles of this invention as set forth herein.

What is claimed is:

1. A stadium advertising system for ordering concession items from a vendor and displaying advertising at events, the system comprising a binder for receiving a front jacket, a rear jacket and one or more panels wherein said panels display advertising indicia on one face and a concession item on an opposing face.

2. The stadium advertising system of claim 1, wherein the binder is provided for use with panels having marginal perforations.

3. The stadium advertising system of claim 1, wherein one or more advertising indicia on a panel face is coordinated with a concession item on an opposing face for marketing purposes.

4. The stadium advertising system of claim 1, wherein the binder is a spiral binder and includes a coil.

5. The stadium advertising system of claim 1, wherein the binder includes one or more rings and wherein the panels are removably disposed within the binder and thereafter removed or replaced for insertion and modification of advertisements and concession items.

6. The stadium advertising system of claim 1, wherein one or more of the panels is laminated.

7. A method of simultaneously advertising and ordering concession items at a live sporting event, the method comprising the steps of:
(a) providing an attendee with a stadium advertising system, the system comprising a binder for receiving a front jacket, a rear jacket and one or more panels wherein said panels display advertising indicia on one face and a concession item on an opposing face.
(b) said attendee selecting a concession item from one of said panels;
(c) said attendee displaying the panel bearing the concession item for ordering and simultaneously displaying the opposing face of the panel bearing the advertising indicia to one or more fellow attendees disposed within viewing distance of the advertisement and positioned to view the advertisement; and
(d) viewing of the advertisement by fellow attendees seated behind the attendee and in neighboring rows, positioned to view the advertisement.

8. The method of claim 8, wherein the binder is a spiral binder and includes a coil.

9. The method of claim 8, wherein the binder includes one or more rings and wherein the panels are removably disposed within the binder and thereafter removed or replaced for insertion and modification of advertisements and concession items.
